(19) United States
(12) Patent Application Publication
(10) Pub. No.: US 2008/0140438 A1
(43) Pub. Date: Jun. 12, 2008

(54) RISK MANAGEMENT TOOL

(75) Inventor: Gary Marvin Bares, Phoenix, AZ (US)

Correspondence Address: MERCHANT & GOULD PC, P.O. BOX 2903, MINNEAPOLIS, MN, 55402-0903, US

(73) Assignee: TeleTech Holdings, Inc., Englewood, CO (US)

(21) Appl. No.: 11/952,850

(22) Filed: Dec. 7, 2007

Related U.S. Application Data
(60) Provisional application No. 60/869,204, filed on Dec. 8, 2006.

(51) Int. Cl. G06Q 99/00

(52) U.S. Cl. 705/1

(57) ABSTRACT

A risk management tool allows a user to enter information about a company of interest to determine if the company demonstrates fraudulent characteristics. The risk management tool contains a fraud radar, a credit velocity indicator, and a fraud database lookup. The credit velocity indicator is a measure of the number of user companies utilizing the risk management tool that are searching for information on the same company. The fraud radar shows a visual representation of the historical fraudulent activity surrounding a given geographical area specified by zip code. The fraud database lookup indicates the matches found for the company of interest and allows a user to drill down on any or all of the matches. These three different measures of risk are combined and displayed graphically for the user, allowing the user to make a better informed decision instead of relying on a single credit resource derived score.

### CROSS-REFERENCES TO RELATED APPLICATIONS

This application claims the benefit of U.S. Provisional Application Ser. No. 60/869,204 filed on Dec. 8, 2006 titled “COMPARATIVE MARKET PRESENCE INDICATOR” which is incorporated herein by reference in its entirety for all that is taught and disclosed therein.

### BACKGROUND

Companies lose hundreds of millions of dollars annually because they are unable to effectively determine whether a potential business partner or company has real operations or is merely a fraudulent setup that appears real. In evaluating companies there is thus a strong need in the market to be able to effectively separate illegitimate and fraudulent business partners and companies from legitimate ones. Since fraud is a significant business problem, and credit reports are often easy to manipulate by unscrupulous companies, improved methods are needed that can provide a quick, proven summary of true fraud risk that allow companies to make better decisions in trying to manage risk.

### SUMMARY

This Summary is provided to introduce in a simplified form a selection of concepts that are further described below in the Detailed Description. This Summary is not intended to identify key features or essential features of the claimed subject matter, nor is it intended to be used to limit the scope of the claimed subject matter.

The detailed description below describes a risk management tool that allows businesses to effectively separate legitimate from fraudulent business partners. The risk management tool contains three distinct components: a fraud radar, a credit velocity indicator, and a fraud database lookup. A user enters information about an entity, such as a company name, address, phone, website, a principals name, and/or claimed revenue. The risk management tool visually displays the results from processing the entered data on the three component portions of one display screen, and enables the user to quickly ascertain the level of fraud risk associated with the company of interest. There are services that attempt to return a single fraud risk score based on credit trade characteristics. The risk management tool combines three different measures of risk and displays them graphically for the user, and thus allows the user to make a better informed decision rather than relying on a single credit resource derived score.

### BRIEF DESCRIPTION OF THE SEVERAL VIEWS OF THE DRAWINGS

FIG. 1 shows a screen shot of a graphical user interface for a risk management tool displayed on a display device of a client computer.

FIG. 2 shows a schematic/block diagram of an embodiment a computer system capable of implementing the risk management tool.

FIG. 3 shows a block flow diagram of a method for utilizing a risk management tool.

### DETAILED DESCRIPTION

The invention may be implemented as a computer process, a computing system, or as an article of manufacture such as a computer program product. The computer program product may be a computer storage medium readable by a computer system and encoding a computer program of instructions for executing a computer process. The computer program product may also be a propagated signal on a carrier readable by a computing system and encoding a computer program of instructions for executing a computer process.

With the computing environment in mind, embodiments of the present invention are described with reference to logical operations being performed to implement processes embodying various embodiments of the present invention. These logical operations are implemented (1) as a sequence of computer implemented steps or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts, or modules. It will be recognized by one skilled in the art that these operations, structural devices, acts, and modules may be implemented in software, in firmware, in special purpose digital logic, and any combination thereof without deviating from the spirit and scope of the present invention as recited within the claims attached hereto.

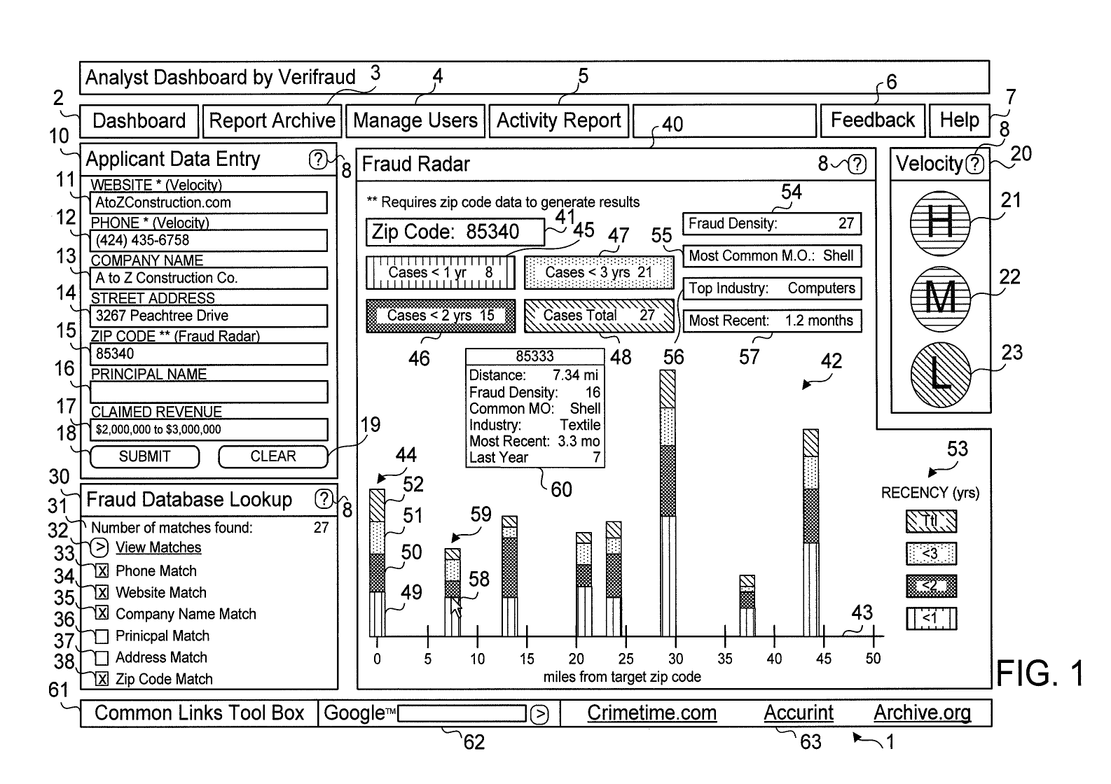

Referring now to the Figures, in which like reference numerals and names refer to structurally and/or functionally similar elements thereof, FIG. 1 shows a screen shot of a graphical user interface for a risk management tool displayed on a display device of a client computer. The client computer may be a stand alone computer system. The screen shot shown may also be delivered by a server computer that may be displayed through a Web browser on a display device of the client computer. Referring now to FIG. 1, Screen Shot 1 shows the user interface for an embodiment of a risk management tool as displayed on a display device of a client computer. Buttons 2-7 allow the user to select various functions of the risk management tool. Buttons 2-7 may be clicked on with a pointing device, such as a mouse, to select certain aspects of the risk management tool. Dashboard Button 2 has been selected and the resulting Screen Shot 1 is shown in FIG. 1. Clicking on Report Archive 3 will return to the display device information on any reports that have been previously generated by the system that were previously stored. The names given to the reports that were saved are displayed, and the user may click on any of the displayed names, and the report will be returned to the display device. Clicking on Manage Users 4 will return to the display device a screen with information about the user's of the risk management tool. User's can be added, deleted, and their activity monitored from this screen. Clicking on Activity Report Button 5 will return to the display device a screen where a user can review an activity summary of what reports have been run and which users ran the reports. Clicking on Feedback Button 6 will return to the display device a screen where a user can provide feedback to the developer of the risk management tool, typically in the form of an email, which can be sent directly to the developers email account. Clicking on Help Button 7 will return to the display device a screen where a user can select various help options, which may include a search text box where the user can type in a subject or question, and search for answers stored in a help database.

The method of utilizing the risk management tool begins with Applicant Data Entry Pane 10. A user may enter one or more pieces of information about a company of interest. For example, a user may enter a website URL in Text Entry Box 11; a telephone number in Text Entry Box 12; a company name in Text Entry Box 13; a street address in Text Entry Box 14; a zip code in Text Entry Box 15; a name of a principal officer of the company in Text Entry Box 16; and the company's claimed or published annual revenues in Text Entry Box 17. Clicking in Text Entry Box 17 causes a drop down menu to appear (not shown) allowing the user to select from several ranges of revenue, such as “Less Than $1,000,000,” “$1,000,000 to $2,000,000,” “$2,000,000 to $3,000,000,” . . . “Greater Than $10,000,000.” In this example, the user selected the range “$2,000,000 to $3,000,000” which is displayed in Text Entry Box 17. Additional Text Entry Boxes may be added to Applicant Data Entry Pane 10 to allow for input of other types of data, such as SIC Codes, or any other type of data determined to be relevant. After making one or more of the above data entries, the user clicks on Submit Button 18 and the risk management tool processes the data entered and will re-display Screen Shot 1 with data that populates one or more of Credit Velocity Indicator Pane 20, Fraud Database Lookup Pane 30, and Fraud Radar Pane 40 depending upon which entries are made. For example, in order to populate Credit Velocity Indicator Pane 20, data must be entered into one or the other of Text Entry Box 11 or Text Entry Box 12. In order to populate Fraud Radar Pane 40, data must be entered into Text Entry Box 15. Clear Button 19 is used to clear data from Applicant Data Entry Pane 10 in order to enter information about another company. Individual Text Entry Boxes may be edited or deleted, and after so doing, clicking on Submit Button 18 will cause the risk management tool to re-display Screen Shot 1 with updated data. Each of the panes displayed, Applicant Data Entry Pane 10, Credit Velocity Indicator Pane 20, Fraud Database Lookup Pane 30, and Fraud Radar Pane 40, each have an Information Button 8, indicated by a question mark. Clicking on any of these Information Buttons 8 will bring up a pop-up window with explanations about the various content of each respective pane, and what type of data can be entered and what formats are acceptable.

Based upon a website URL or telephone number being entered in Text Entry Box 11 or Text Entry Box 12, and then clicking on Submit Button 18, one of three velocity indicators will be highlighted in Credit Velocity Indicator Pane 20 in a stop light type format. High Velocity Indicator 21 is displayed typically in the color red, Medium Velocity Indicator 22 is displayed typically in the color yellow, and Low Velocity Indicator 23 is displayed typically in the color green. The Credit Velocity Indicator is a measure of the number of user companies utilizing the risk management tool that are searching for information on the same company of interest. The results are displayed visually according to flexible and adjustable tolerance levels based upon the number of searches and the number of users.

Experience has shown that one of the main indicators of credit fraud is a spike in credit activity across an industry or industries compared to historical levels. Fraudulent companies will often flood the market with credit applications over a relatively short period of time, such as a few days. The Credit Velocity Indicator is a quick, visual representation of the number of users who are searching on the same company due to a credit application being submitted to them.

The criteria for high, medium, and low ranges can be adjusted based on the number of customers using the risk management tool as well as other factors such as the size of the subject company. For example, one would expect a company with tens of billions of dollars of revenue to be more active in the credit environment than a small home-based business. Thus, velocity measures are adjusted for size factors and also for the number of users. For example, if there are only ten users of the risk management tool, and four of the users are searching on the same company, this indicates a 40% hit rate across the client user base. On the other hand, if there are 10,000 companies using the risk management tool, and four of them are searching on the same company, that is a 0.04% hit rate, which is likely to be viewed as a less significant result in light of the size of the client user base. Thus, the client user base and company size may determine what an individual client user will deem significant. A user my select what hit rates will trigger a high, medium, or low credit velocity indicator output, and may also select how company size will affect the hit rates. Some client users may want to flag any companies that are even close to being high velocity, and other client users, due to manpower or other consideration, may only want to see results for only very high velocity indications. Thus, different client users may get different results for the same company based upon how they have altered the default settings. The data stored in the risk management database for credit velocity indications may be gathered from independent market sources or developed internally.

In the example shown in Screen Shot 1, a user has entered data in Text Entry Boxes 11, 12, 13, 14, 15, and 17, and then clicked on Submit Button 18. Based upon the default settings set for the risk management tool, or based upon the user selected criteria, Low Velocity Indicator 23 is displayed in a green color indicating that there is not much credit activity associated with this particular company. High Velocity Indicator 21 and Medium Velocity Indicator 22 are grayed-out and displayed in a gray color.

Fraud Radar Pane 40 shows a visual representation of the historical fraudulent activity surrounding a given geographical area specified by zip code. By viewing Fraud Radar Pane 40 the user can ascertain the fraud density, recency of fraud, types of fraud, industry targeted, and distance, from a current business located within a specified zip code. When evaluating a business entity for degree of fraud risk, it is important to quickly determine the fraudulent activity that has historically occurred in nearby areas since fraud activity is consistently higher in some geographic locations than others. Fraud Radar Pane 40 makes this assessment simple and quick by visually representing pertinent data in a radar type format with color coding used to represent the necessary comparative data. This approach quickly and visually allows the user to identify the detailed and segmented fraud risk of both a given zip code and the surrounding areas which are represented in distance from the specified search zip code. Typical prior approaches to this problem only return individual fraud records when searched and usually no visual representation is given. Thus the user has to read through each record in order to get the overall historical fraud record details of a given zip code, and then the user would have to search each surrounding zip code separately and repeat the interpretive process in the same way.

Fraud Radar Pane 40 allows users to ascertain a measure of geographically specific, historically fraudulent activity for a given area, and allows the user to determine the likely fraud risk for both a companies current location as well as its surrounding area. Having information on surrounding areas is important since fraud perpetrators frequently move around to neighboring zip codes and the overall fraud risk also tends to increase if an area either has historically high fraud activity and/or is surrounded by such areas. Fraud Radar Pane 40 also allows the user to determine other data elements from the fraud activity such as dates and frequency of previous frauds as well as types of fraud and industries targeted, which allow for more accurate risk-management decisions with respect to how similar a company's traits are to previous fraudulent companies in the area. This functionality allows users to make better risk management decisions which will result in reduced fraud losses while also lowering the false-positive rate.

In the example shown in Screen Shot 1, the zip code “85340” was entered into Text Entry Box 15. Upon the user clicking on Submit Button 18, Fraud Radar Pane 40 was populated with the data shown. Searched Zip Code Box 41 contains the zip code entered into Text Entry Box 15. Vertical Bar Graph 42 shows the incidences of fraud within other zip codes that lie within a 50 mile radius of the Searched Zip Code “85340” as shown on Axis 43. Vertical Bar 44 represents the fraud data associated with Searched Zip Code “85340.” This data is further defined in Boxes 45, 46, 47, and 48. Box 45 indicates that there were eight fraudulent companies that perpetrated at least one fraud incidence that occurred less than one year from the current date within Searched Zip Code “85340.” Box 45 is typically displayed in a color, such as red. Segment 49 of Vertical Bar 44 is the visual representation of this data, the eight fraudulent companies. Segment 49 is also displayed in the same color, red, as Box 45.

Box 46 indicates that there were fifteen fraudulent companies that perpetrated at least one fraud incidence that occurred less than two years from the current date within Searched Zip Code “85340,” which means that seven fraudulent companies perpetrated at least one fraud incidence in the second year past from the current date. Box 46 is typically displayed in a color, such as orange. Segment 50 is the visual representation of this data, the seven fraudulent companies. Segment 50 is also displayed in the same color, orange, as Box 46. Segments 49 and 50 combined represent the fifteen fraudulent companies.

Box 47 indicates that there were twenty-one incidences of fraud that occurred less than three years from the current date within Searched Zip Code “85340,” which means that six fraudulent companies perpetrated at least one fraud incidence in the third year past from the current date. Box 47 is typically displayed in a color, such as yellow. Segment 51 is the visual representation of this data, the six fraudulent companies. Segment 51 is also displayed in the same color, yellow, as Box 47. Segments 49, 50, and 51 combined represent the twenty-one fraudulent companies.

Box 48 indicates that twenty-seven incidences of fraud have occurred in total. This means that six fraudulent companies perpetrated at least one fraud incidence greater than three years ago from the current date within Searched Zip Code “85340.” The fraud database may keep data for up to seven year or up to ten years or any other specified period of time. Box 48 is typically displayed in a color, such as green. Segment 52 is the visual representation of this data, the six fraudulent companies. Segment 52 is also displayed in the same color, green, as Box 48. Segments 49, 50, 51, and 52 combined represent the twenty-seven fraudulent companies. Recency Legend 53 indicates the colors associated with the time frames discussed above.

Further information regarding the incidences of fraud associated with Searched Zip Code “85340” are provided in Boxes 54, 55, 56, and 57. Box 54 shows the total Fraud Density for the Searched Zip Code “85340” of twenty-seven fraudulent companies. Box 55 shows the most common modus operandi of the incidences of fraud, which in this case, is a shell. In a shell company fraud, the shell company may hit on a large number of similar companies, such as thirty, forty or fifty computer companies. A shell company is defined as having the appearance infrastructure in place but does not actually have any actual operations. A shell company appears to be a legitimate business from the outside, but inside there is no real business activity taking place. The shell company has incorporation papers, credit reports, possibly a very nice website, and other indicia of a functioning company, but no actual operations, and very few employees that are not adequate to support the level of business they claim to have.

In a takeover fraud, the fraudulent company will go in and buy an actual company in order to use its positive history as a way to gain credit from unsuspecting creditors. A few of the original employees may be retained, but most are let go. Sales figures are then inflated and disseminated out to credit reporting agencies. The company will then typically send out hundreds of credit applications at once or over a few days time. Once credit is obtained, then the principals behind the takeover disappear.

Corporate identify theft is another type of fraud. Here the perpetrator assumes the identity of a legitimate and credit worthy organization. They acquire information about a company, such as bank account numbers, trade references, the identities of the principals, etc. They may then order goods and services from other companies, posing as the legitimate company, but substitute a different delivery address for the legitimate company. They then abscond with the goods when they are delivered.

Box 56 shows that the top industry that was the target of the frauds was the computer industry. Box 57 shows that the most recent fraudulent company was identified 1.2 months prior to the current date.

The remaining vertical bars displayed in Vertical Bar Graph 42 represent fraudulent companies in the surrounding zip codes that are within fifty miles of the Searched Zip Code “85340.” The heights of the vertical bars are relative to each other and indicate the number of fraudulent companies. For example, vertical bars shown in Vertical Bar Graph 42 that are shorter than Vertical Bar 44 represent fewer fraudulent companies than Vertical Bar 44, and vertical bars that are taller than Vertical Bar 44 represent more fraudulent companies than Vertical Bar 44.

In Fraud Radar Pane 40 a user has moved Mouse Pointer 58 over Vertical Bar 59 and has allowed Mouse Pointer 58 to hover over Vertical Bar 59 for a brief period of time. As a result of this mouse hover action, Pop-Up Box 60 is displayed within Fraud Radar Pane 40. Pop-Up Box 60 displays more items of information about Vertical Bar 59. The zip code for Vertical Bar 59 is identified as “85333.” Zip code “85333” is located 7.34 miles from Searched Zip Code “85340.” The Fraud Density for this zip code is 16. The Common Modus Operandi for this zip code is a shell. The Top Industry targeted is textiles. The most recently identified fraudulent company was identified 3.3 months ago from the current date in this zip code. Finally, there were seven fraudulent companies identified less than one year from the current date. By moving and hovering Mouse Pointer 58 over any of the other vertical bars will cause a new Pop-Up Box to appear containing information on the vertical bar hovered on. Thus, the user can rapidly gain a good picture of the fraudulent activity surrounding Searched Zip Code “85340.” The U.S. Postal Service, as well as other vendors, can provide distance information between zip code areas.

Fraud Database Lookup Pane 30 provides access to a database containing historical and emergent records pertaining to fraudulent companies and individuals that have been compiled over a period of years. Each record in the fraud database may contain data items including date of activity, company name, address, phone number, website URL, principal(s), and trade reference identifiers. The fraud database is managed in a proactive fashion in that the database is updated with information with respect to known perpetrator activity, such as new company registrations, current addresses, phone numbers, etc. As a result, users can spot potential fraud based on actions of known perpetrators rather than relying on a “historical” record which often is only recognized during various stages of the fraud lifecycle which, unfortunately, is usually not until after victims have reported the fraud. Since credit fraud is very often carried out by individuals and groups that are repeatedly involved in this type of activity, the fraud database allows users to search for links between a current company and possible links to previous credit fraud activity as well as identify the current location and possible emerging business affiliations of perpetrators contained in the fraud database from previous fraud activities. The fraud database is unique in that data is captured that relates to following the participants of previous fraud activity forward, and entering data such as new companies they establish, and new addresses they are using so that the fraud database becomes dynamic and forward looking rather than just reactive and historically backward looking. With other approaches the databases are typical updated only once fraud activity has been identified. The fraud database associated with the risk management tool is proactive and updates fraud perpetrator behavior before their next attempt is carried out. Being proactive in such a way also allows users to spot potential fraud earlier than when relying on traditional reactive and purely historical databases.

Companies that are listed in the fraud database have been identified as having characteristics consistent with previous fraudulent companies. Typically it is not the surface level information about a company that will cause a company to be included in the fraud database. A lot of research and digging is done to gather additional information. Tracking the activities of known principals involved in previous frauds is one source of investigation. These individuals are often careless when registering domain names, or new company registrations through the Secretaries of State across the country, or some other type of activity, leaving a paper trail that can be followed. Cooperation with other organizations, outsourcing operations, and contact with major companies across the country are additional sources of information that are evaluated for identifying fraud for inclusion in the fraud database. Only after thorough investigation and trust in established third party relationships is new information added to the fraud database. There must be enough characteristics that correspond with traditional fraud or historical fraudulent activity before a company or principal is entered into the fraud database.

In the example shown in Screen Shot 1, the zip code “85340” was entered into Text Entry Box 15. Upon the user clicking on Submit Button 18, Fraud Database Lookup Pane 30 was populated with the data shown. Number of Matches Found Indicator 31 indicates that two matches were found in the fraud database based upon the data entered into Applicant Data Entry Pane 10. Phone Match Indicator 33 is checked, indicating that the phone number entered in Text Entry Box 12 matches with at least one record in the fraud database. Website Match Indicator 34 is checked, indicating that the website URL entered in Text Entry Box 11 matches with at least one record in the fraud database. Company Name Match Indicator 35 is checked, indicating that the company name entered in Text Entry Box 13 matches with at least one record in the fraud database. Principal Match Indicator 36 is not checked, indicating that no match was found in the fraud database. It can be seen that no data was entered in Text Entry Box 16 for a principal, which is why there is no match. Address Match Indicator 37 is not checked, indicating that no match was found in the fraud database for the address entered in Text Entry Box 14. Zip Code Match Indicator 38 is checked, indicating that the zip code entered in Text Entry Box 15 matches with at least one record in the fraud database. Clicking by the user on View Matches Button 32 will return a new screen to the display showing more information from the fraud database regarding the various matches found.

Tool Box Bar 61 provides the user with quick access to various resources. An internet search function is provided in Search Box 62, which in this embodiment is the Google™ search engine. Quick Links Box 63 is customizable by the user. The user can populate Quick Links Box 63 with the URL links of frequently used internet resources.

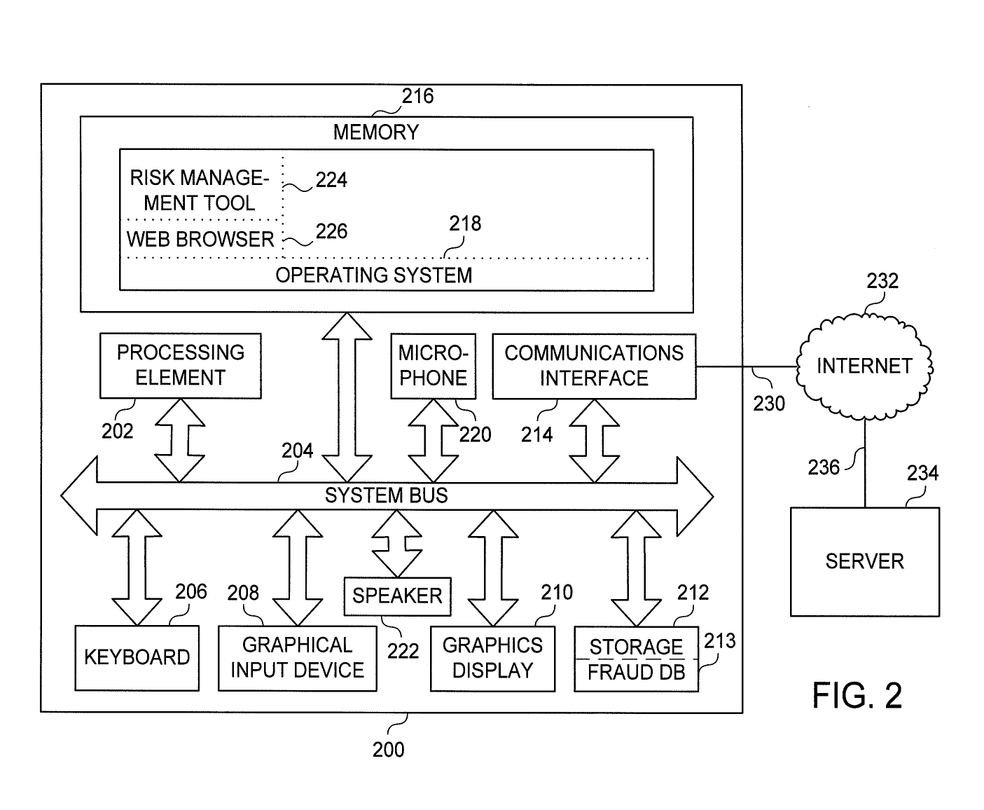

FIG. 2 shows a schematic/block diagram of a computer system capable of implementing the risk management tool. The risk management tool may also be implemented on a mainframe computer system, a stand alone personal computer system, a networked distributed computer system, hand held computing devices, or any other suitable processing system. The computer system shown in FIG. 2 is one of many different embodiments possible.

Referring now to FIG. 2, components of a Computer System 200 may include, but are not limited to, the following elements. Processing Element 202 communicates to other elements of the Computer System 200 over a System Bus 204. A Keyboard 206 allows a user to input information into Computer System 200, and a Graphics Display 210 allows Computer System 200 to output information to the user. Graphics Display 210 may also be touch screen enabled, allowing a user to input information into Computer System 200 through this mode. Graphical Input Device 208, which may be a mouse, joy stick, or other type of pointing device, is also used to input information. A Storage 212 is used to store data and programs within Computer System 200, including Fraud Database 213. A Memory 216, also connected to System Bus 204, contains an Operating System 218, and the Risk Management Tool Software 224. A Microphone 220 and a Speaker 222 are also connected to System Bus 204. Microphone 220 may be integral to or externally connected to Computer System 200. A Communications Interface 214 is also connected to System Bus 204. Communications Interface 214 may have one or more serial ports, parallel ports, infrared ports, and the like. Connectable through Communications Interface 214 may be an external printer or scanner, as well as access to the Internet 232 via Communication Channel 230, or to a computer network (LAN or WAN) or to any other appropriate communication channel (not shown in FIG. 2). Computer System 200 may also communicate with Server 234 via Communication Channel 236. Fraud Database 213 may be stored on, or accessed from, Server 234 when the risk management tool is implemented on a networked distributed computer system or over the internet and accessed by the user through a Web Browser 226 in Computer System 200.

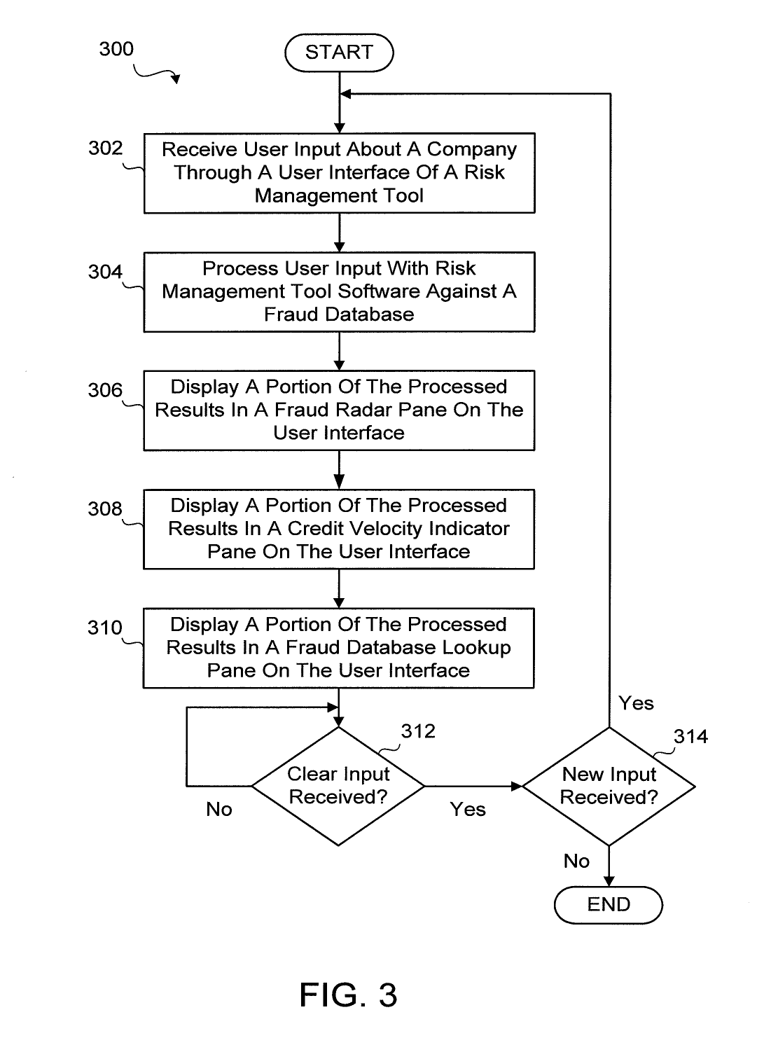

FIG. 3 shows a block flow diagram of a method for utilizing a risk management tool. Referring now to FIG. 3, the Method 300 begins in Block 302 where user input about a company is received via a user interface of a risk management tool, such as that shown in Screen Shot 1 of FIG. 1. The user input is one or more of a company website URL, a telephone number, a company name, a street address, a zip code, a principal name, and a claimed revenue. In Block 304 the user input is processed by risk management tool software, such as Risk Management Tool Software 224 running in a computer system, such as Computer System 200, as shown in FIG. 2.

After processing, in Block 306, if a zip code was entered in Block 302, a lo portion of the processed results are displayed in a fraud radar format, such as Fraud Radar Pane 40 shown in FIG. 1. In Block 308, if a web site or a telephone number was entered in Block 302, a portion of the processed results are displayed in a stop light format, such as Credit Velocity Indicator Pane 20 shown in FIG. 1. In Block 310, based upon any input entered in Block 302, a portion of the processed results are displayed in a match lookup format, such as Fraud Database Lookup Pane 30 shown in FIG. 1.

Block 312 determines when clear input is received from the user, such as the user clicking on Clear Button 19 shown in FIG. 1. When clear input is received, then Block 314 determines if new user input is received, such as from Applicant Data Entry Pane 10 shown in FIG. 1. If new user input is received, then the method returns to Block 302. If no new user input is received in Block 314, then the method ends.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It will be understood by those skilled in the art that many changes in construction and widely differing embodiments and applications will suggest themselves without departing from the scope of the disclosed subject matter.

What is claimed is:

1. A method for assessing risk associated with an entity, the method comprising the steps of:
(a) receiving user input about the entity through a user interface displayed on a display device of a computer implemented risk management application;
(b) processing by said risk management application said user input about the entity against a fraud database;
(c) displaying graphically on said display device a first data from said processing step (b) in a first portion of said user interface, wherein said first data is displayed as a visual representation of historical fraudulent activity surrounding a given geographical area specified by said user input for the entity, and further wherein said displayed visual representation of historical fraudulent activity shows at least a one of a fraud density, a recency of fraud, and a distance from the entity where said historical fraudulent activity has occurred.

2. The method according to claim 1 wherein step (a) further comprises:
receiving user input about the entity that is at least a one of a website URL, a telephone number, a company name, a street address, a zip code, a principal name, and a claimed revenue.

3. The method according to claim 1 further comprising the step of:
displaying graphically on said display device a second data from said processing step (b) in a second portion of said user interface, wherein said second data is displayed as a visual representation of a number of users utilizing said risk management application that are searching for information on the entity.

4. The method according to claim 3 wherein said displaying step further comprises the step of:
displaying said second data in a stop light type format according to a predetermined criteria.

5. The method according to claim 4 wherein said displaying step further comprises the steps of:
if said number of users falls in a high range based upon said predetermined criteria, displaying a high velocity indicator in a first color and displaying a medium velocity indicator in a second color and a low velocity indicator in said second color;
if said number of users falls in a medium range based upon said predetermined criteria, displaying said medium velocity indicator in a third color and displaying said high velocity indicator and said low velocity indicator in said second color; and
if said number of users falls in a low range based upon said predetermined criteria, displaying said low velocity indicator in a fourth color and displaying said high velocity indicator and said medium velocity indicator in said second color.

6. The method according to claim 4 wherein said predetermined criteria is based upon said number of users and a size of the entity.

7. The method according to claim 1 wherein said displaying step (c) further comprises the step of:
displaying said visual representation of historical fraudulent activity as a vertical bar graph having a plurality of vertical bars, wherein each of said vertical bars is comprised of a plurality of sections, and each of said vertical bars is positioned at a distance from a first vertical bar, which represents the entity, wherein each said distance represents to scale a distance between a zip code of the entity and a plurality of zip codes within a predetermined radius from said zip code of the entity.

8. The method according to claim 7 wherein said displaying step further comprises the steps of:
displaying a first component of each of said vertical bars to represent a number of fraudulent entities having a recency of less than one year from a current date;
displaying a second component of each of said vertical bars to represent a number of fraudulent entities having a recency of less than two years but more than one year from a current date;
displaying a third component of each of said vertical bars to represent a number of fraudulent entities having a recency of less than three years but more than two years from a current date; and
displaying a fourth component of each of said vertical bars to represent a number of fraudulent entities having a recency of more than three years from a current date.

9. The method according to claim 8 wherein said displaying step further comprises the steps of:
displaying said first components of each of said vertical bars in a fifth color;
displaying said second components of each of said vertical bars in a sixth color;
displaying said third components of each of said vertical bars in a seventh color; and
displaying said first components of each of said vertical bars in an eighth color.

10. The method according to claim 7 further comprising the steps of:
receiving mouse hover input over a one of said plurality of vertical bars;
displaying a pop-up window in said first portion of said user interface, wherein said pop-up window contains data about a number of fraudulent entities having a zip code represented by said one of said plurality of vertical bars.

11. The method according to claim 10 wherein said displaying step further comprises the steps of:
displaying in said pop-up window at least a one of the following items of information associated with said one of said plurality of vertical bars: a distance from said zip code of the entity to said zip code of said number of fraudulent entities, a fraud density, a most common modus operandi of fraud, a most common industry, a most recent fraud event, and a total number of fraud events less than one year from said current date.

12. The method according to claim 1 further comprising the step of:
displaying graphically on said display device a third data from said processing step (b) in a third portion of said user interface, wherein said third data is displayed as a list of a number of types of matches of the entity against said fraud database.

13. The method according to claim 12 wherein said displaying step further comprises the step of:
displaying at least a one of the following types of matches: a phone match, a website match, a company name match, a principal name match, an address match, and a zip code match.

14. A tangible computer readable storage medium storing instructions that, when executed by a processor, causes the processor to perform a method for assessing risk associated with an entity, the method comprising the steps of:
(a) receiving user input about the entity through a user interface displayed on a display device of a computer implemented risk management application;
(b) processing by said risk management application said user input about the entity against a fraud database;
(c) displaying graphically on said display device a first data from said processing step (b) in a first portion of said user interface, wherein said first data is displayed as a visual representation of historical fraudulent activity surrounding a given geographical area specified by said user input for the entity, and further wherein said displayed visual representation of historical fraudulent activity shows at least a one of a fraud density, a recency of fraud, and a distance from the entity where said historical fraudulent activity has occurred;
(d) displaying graphically on said display device a second data from said processing step (b) in a second portion of said user interface, wherein said second data is displayed as a visual representation of a number of users utilizing said risk management application that are searching for information on the entity; and
(e) displaying graphically on said display device a third data from said processing step (b) in a third portion of said user interface, wherein said third data is displayed as a list of a number of types of matches of the entity against said fraud database.

15. The tangible computer readable storage medium according to claim 14 further comprising the steps of:
displaying said first data as a vertical bar graph having a plurality of vertical bars, wherein each of said vertical bars is comprised of a plurality of sections, and each of said vertical bars is positioned at a distance from a first vertical bar, which represents the entity, wherein each said distance represents to scale a distance between a zip code of the entity and a plurality of zip codes within a predetermined radius from said Zip code of the entity;
displaying said second data in a stop light type format according to a predetermined criteria; and
displaying said third data as at least a one of the following types of matches: a phone match, a website match, a company name match, a principal name match, an address match, and a zip code match.

16. A computer system for assessing risk associated with an entity, the computer system comprising:
a memory;
a processor connectable to said memory;
a risk management software application program executable by said processor when loaded into said memory;
a fraud database accessible by said risk management software application program;
a user interface of said risk management software application program for receiving input from a user about the entity, wherein said input from said user about the entity is processed by said risk management software application program against said fraud database;
a display device for displaying output from said risk management software application program to said user; and
a first data from said processing of said input, wherein said first data is displayed in a first portion on said display device, wherein said first data comprises:
a visual representation of historical fraudulent activity surrounding a given geographical area specified by said input for the entity, wherein said displayed visual representation of historical fraudulent activity shows at least a one of:
a fraud density;
a recency of fraud; and
a distance from the entity where said historical fraudulent activity has occurred.

17. The system according to claim 16 wherein said user input about the entity that is at least a one of a website URL, a telephone number, a company name, a street address, a zip code, a principal name, and a claimed revenue.

18. The system according to claim 17 further comprising:
a second data from said processing of said input, wherein said second data is displayed in a second portion on said display device, wherein said second data comprises:
a visual representation of a number of users utilizing said risk management software application program that are searching for information on the entity.

19. The system according to claim 18 further comprising:
a stop light type format for displaying said second data according to a predetermined criteria.

20. The system according to claim 19 wherein said stop light format further comprises:
a high velocity indicator, wherein if said number of users falls in a high range based upon said predetermined criteria, said high velocity indicator is displayed in a first color;
a medium velocity indicator, wherein if said number of users falls in a medium range based upon said predetermined criteria, said medium velocity indicator is displayed in a second color; and
a low velocity indicator, wherein if said number of users falls in a low range based upon said predetermined criteria, said low velocity indicator is displayed in a third color.

21. The system according to claim 19 wherein said predetermined criteria is based upon said number of users and a size of the entity.

22. The system according to claim 21 wherein said visual representation of historical fraudulent activity further comprises:
a vertical bar graph having a plurality of vertical bars, wherein each of said vertical bars is comprised of a plurality of sections, and each of said vertical bars is positioned at a distance from a first vertical bar, which represents the entity, wherein each said distance represents to scale a distance between a zip code of the entity and a plurality of zip codes within a predetermined radius from said zip code of the entity.

23. The system according to claim 22 wherein each of said vertical bars further comprises:
a first component which represents a number of fraudulent entities having a recency of less than one year from a current date;
a second component which represents a number of fraudulent entities having a recency of less than two years but more than one year from a current date;
a third component which represents a number of fraudulent entities having a recency of less than three years but more than two years from a current date; and
a fourth component which represents a number of fraudulent entities having a recency of more than three years from a current date.

24. The system according to claim 22 further comprising:
a pop-up window displayable in said first portion of said display device when mouse hover input over a one of said plurality of vertical bars is received, wherein said pop-up window further comprises:
a data about a number of fraudulent entities having a zip code represented by said one of said plurality of vertical bars.

25. The system according to claim 24 wherein said data about a number of fraudulent entities further comprises at least a one of the following items of information associated with said one of said plurality of vertical bars:
a distance from said zip code of the entity to said zip code of said number of fraudulent entities;
a fraud density;
a most common modus operandi of fraud;
a most common industry;
a most recent fraud event; and
a total number of fraud events less than one year from said current date.

26. The system according to claim 16 further comprising:
a third data from said processing of said input, wherein said third data is displayed in a third portion on said display device, wherein said third data comprises:
a list of a number of types of matches of the entity against said fraud database.

27. The system according to claim 26 wherein said list further comprises at least a one of the following types of matches:
a phone match;
a website match;
a company name match;
a principal name match;
an address match; and
a zip code match.
